(19) United States
(12) Patent Application Publication
(10) Pub. No.: US 2026/0018311 A1
(43) Pub. Date: Jan. 15, 2026

(54) RADIOGRAPHY SOURCES AND RADIATION EXPOSURE DEVICES HAVING KEYED LOCKING DEVICES

(71) Applicant: QSA Global Inc., Burlington, MA (US)

(72) Inventors: Paul Benson, Waltham, MA (US); David Wood, Waltham, MA (US)

(21) Appl. No.: 19/214,685

(22) Filed: May 21, 2025

Related U.S. Application Data
(60) Provisional application No. 63/651,128, filed on May 23, 2024.

(51) Int. Cl. G21F 1/00; G01N 23/04; G01N 23/06

(52) U.S. Cl. CPC G21F 1/00; G01N 23/04; G01N 23/06

(57) ABSTRACT

Disclosed example radiographic source assemblies include: a radiographic source capsule comprising a sealed radiographic material; a drive cable connected to the radiographic source capsule at a distal end of the drive cable; and a control connector, a distal end of the remote control connector being connected to a proximal end of the drive cable and configured to receive a remote connector, the control connector comprising a lock retention feature and a keying feature positioned closer than the lock retention feature to the proximal end of the control connector.

### RELATED APPLICATIONS

The present application claims the benefit of U.S. Provisional Patent Application Ser. No. 63/651,128, filed May 23, 2024, entitled “RADIOGRAPHY SOURCES AND RADIATION EXPOSURE DEVICES HAVING KEYED LOCKING DEVICES.” The entirety of U.S. Provisional Patent Application Ser. No. 63/651,128 is expressly incorporated herein by reference.

### FIELD OF THE DISCLOSURE

This disclosure relates generally to radiography and, more particularly, to radiography sources and radiation exposure devices having keyed locking devices.

### BACKGROUND

Industrial radiography is often used for producing images of objects that are otherwise difficult to inspect, and involves exposing a source of high-energy radiation (e.g., gamma rays) and collecting penetrating and/or scattered rays to form a radiographic image. When not in use, gamma ray sources, such as radioactive isotopes, are stored in shielding devices.

### SUMMARY

Radiography sources and radiation exposure devices having keyed locking devices are disclosed, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIGS. 1A and 1B illustrate an example radiography system having a source exposure device for providing radiation for radiography, in accordance with aspects of this disclosure.

FIGS. 2A and 2B illustrate another example radiography system having a source projector device for providing radiation for radiography, in accordance with aspects of this disclosure.

FIG. 3A is a cross-sectional view of an example connector lock assembly that may be used to implement the lock assemblies of FIGS. 1A-2B.

FIG. 3B illustrates the example connector lock assembly of FIG. 3A including a keyed control connector of a radiographic source assembly engaged with the sleeve.

FIG. 4 illustrates an example radiographic source assembly having a keyed control connector, in accordance with aspects of this disclosure.

FIGS. 5A and 5B are perspective views of the example keyed control connector of FIG. 4.

FIG. 6 is a flowchart representative of an example method which may be performed to load a radiographic source assembly including a keyed control connector into a radiographic source assembly having a keyed connector lock assembly, in accordance with aspects of this disclosure.

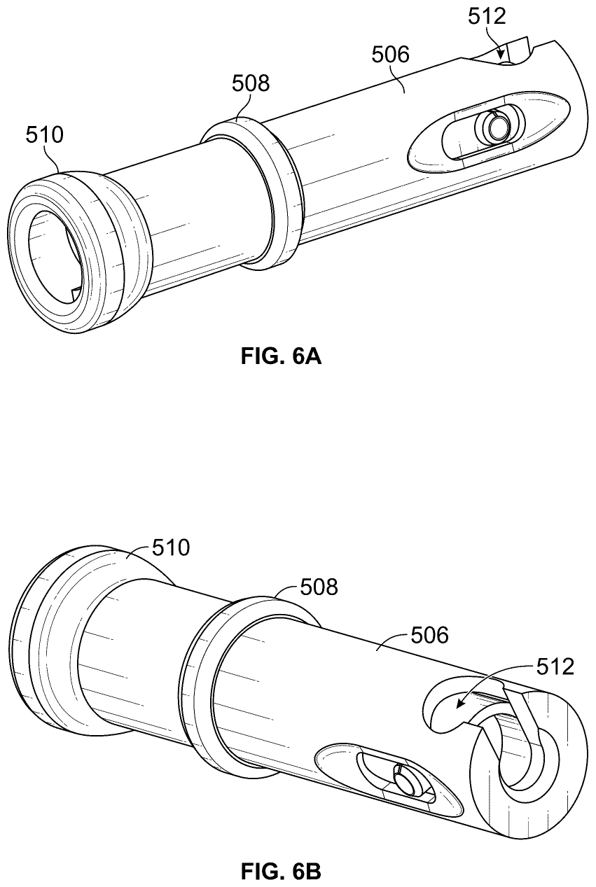

FIG. 7 is a flowchart representative of an example method which may be performed to load a radiographic source assembly including a keyed control connector into a radiographic source projector having a keyed connector lock assembly.

The figures are not necessarily to scale. Wherever appropriate, similar or identical reference numerals are used to refer to similar or identical components.

### DETAILED DESCRIPTION

For the purpose of promoting an understanding of the principles of the claimed technology and presenting its currently understood, best mode of operation, reference will be now made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

Disclosed example radiographic source assemblies include: a radiographic source capsule comprising a sealed radiographic material; a drive cable connected to the radiographic source capsule at a distal end of the drive cable; and a control connector, a distal end of the remote control connector being connected to a proximal end of the drive cable and configured to receive a remote connector, the control connector comprising a lock retention feature and a keying feature positioned closer than the lock retention feature to the proximal end of the control connector.

In some example radiographic source assemblies, the lock retention feature includes a ball-shaped portion or a ring-shaped portion of the remote control connector. In some example radiographic source assemblies, the lock retention feature has a larger diameter than the keying feature. In some example radiographic source assemblies, the keying feature comprises a ball-shaped portion or a ring-shaped portion of the remote control connector. In some example radiographic source assemblies, at least one of the lock retention feature or the keying feature is integrally formed with the control connector.

In some example radiographic source assemblies, at least one of the lock retention feature or the keying feature is permanently attached to the control connector. a proximal end of the keying feature is at least 12.5 millimeters closer than a distal end of the control connector.

Disclosed example radiographic source projectors include: a radiographic source passage extending through the radiographic source projector from a control end to an exposure end; and a connector lock assembly at the control end of the radiographic source passage, the connector lock including: a sliding lock having a first aperture and a channel and configured to slide between a locked position and an unlocked position, the first aperture having a larger diameter than the channel; a first biasing member configured to bias the sliding lock towards the locked position; a sleeve configured to engage the sliding lock when the sliding lock is in the unlocked position; and a second biasing member configured to bias the sleeve towards the sliding lock; wherein the sleeve includes a retention feature and a keying feature configured to allow a control connector of a radiographic source assembly having matching keying features to disengage the sleeve from the sliding lock.

In some example radiographic source projectors, the sleeve includes an internal volume having a proximal end and a distal end, the distal end being closer to the sliding lock, in which a first portion of the internal volume of the sleeve has a first diameter and a second portion of the internal volume has a second diameter, the first diameter being larger than the second diameter. In some example radiographic source projectors, the sleeve includes an action surface at a proximal end of the first portion. In some example radiographic source projectors, the action surface is at least 12 millimeters from the distal end of the sleeve toward the proximal end of the sleeve. In some example radiographic source projectors, the sleeve is configured to remain engaged with the sliding lock in the absence of the keying features.

In some disclosed examples, another radiographic source projector includes: a radiographic source passage extending through the radiographic source projector from a control end to an exposure end; and a connector lock assembly at the control end of the radiographic source passage, the connector lock including: a sliding lock having a first aperture and a channel and configured to slide between a locked position and an unlocked position, the first aperture having a larger diameter than the channel; a first biasing member configured to bias the sliding lock towards the locked position; a sleeve configured to engage the sliding lock when the sliding lock is in the unlocked position; and a second biasing member configured to bias the sleeve towards the sliding lock; in which the sleeve includes a retention feature and a first keying feature; and a radiographic source assembly, including: a radiographic source capsule including a sealed radiographic material and configured to travel through the radiographic source passage; a drive cable connected to the radiographic source capsule at a distal end of the drive cable; and a control connector, a distal end of the control connector being connected to a proximal end of the drive cable and configured to receive a remote connector, the control connector including: a lock retention feature configured to retain the control connector in a locked position within the sleeve when the sliding lock is in the locked position; and a second keying feature positioned closer than the lock retention feature to the proximal end of the control connector and configured to engage the first keying feature to disengage the sleeve from the sliding lock as the control connector moves toward a proximal end of the sleeve.

In some example radiographic source projectors, the sleeve includes an internal volume having a proximal end and a distal end, the distal end being closer to the sliding lock, wherein a first portion of the internal volume of the sleeve has a first diameter and a second portion of the internal volume has a second diameter, the first diameter being larger than the second diameter. In some example radiographic source projectors, the second keying feature of the control connector has a diameter that is smaller than the first diameter and larger than the second diameter.

In some example radiographic source projectors, the first keying feature includes an action surface at a proximal end of the first portion, and the second keying feature is configured to actuate the sleeve via the action surface. In some example radiographic source projectors, the action surface is at least 12 millimeters from the distal end of the sleeve toward the proximal end of the sleeve.

Some example radiographic source projectors further includes a remote control, having: a remote connector configured to releasably connect to a proximal end of the control connector; a control cable; and an actuator configured to actuate the remote connector via the control cable by extending the remote connector and retracting the remote connector, in which the remote connector includes a stop feature configured to limit retraction, such that a second control connector having the lock retention feature and lacking the second keying feature is stopped by the stop feature from retracting a sufficient distance for the lock retention feature to actuate the sleeve.

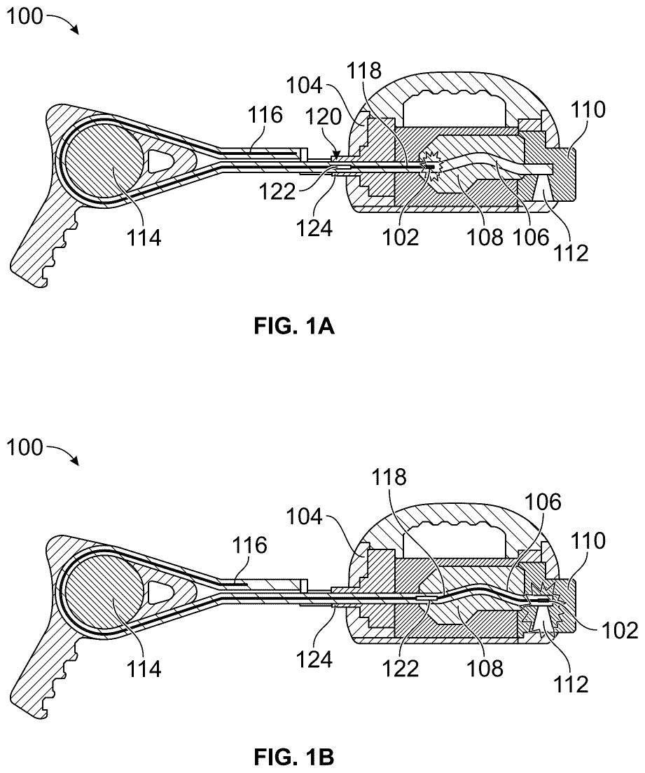

FIGS. 1A and 1B illustrate an example radiographic source projector 100 having a source projector for emitting radiation to perform radiography. The radiographic source projector 100 includes a radiographic source capsule 102 (also referred to herein as a radiation source) which is contained within a radiography source housing 104 (also referred to as a package). The example housing 104 is configured to meet the requirements of a Type A and B package under the International Atomic Energy Agency Safety Standards, Regulations for the Safe Transport of Radioactive Material, 2012 and 2018 Editions, SSR-6.

The example radiographic source capsule 102 includes a radiographic source capsule including a sealed radiographic material. The sealed radiographic material may include Iridium-192, Cobalt-60, Caesium-137, Ytterbium-169, Thallium-201, Hafnium-175 (or thermal neutron-irradiated Hafnium-174), and/or any other radiography isotope which emits radiation (e.g., gamma rays, X-rays, etc.) due to decay of the material.

The radiographic source capsule 102 is positioned in a radiographic source passage 106 (e.g., a source tube) within a shield 108 within the housing 104. The radiographic source passage 106 may be a tungsten-based tube, and the example shield 108 is a depleted uranium-based shield. However, other radiographic source passage 106 materials and/or shielding materials may be used. When positioned in a stored position as shown in FIG. 1A, emissions from the radiographic source capsule 102 are shielded by the shield 108. As an end of the shield 108, the radiographic source passage 106 and shield are connected to an outlet port 110 or collimator. The outlet port 110 may be a similar shielding material as the shield 108, but includes an aperture 112 through which radiation emissions may be projected from the radiographic source projector 100 in a desired direction.

The example radiographic source capsule 102 is assembled into a radiographic source assembly 120 with a drive cable 118 and a control connector 122.

To project gamma rays for radiography, the example radiographic source capsule 102 is moved via the radiographic source passage 106 into a projection position within the outlet port 110 and adjacent the aperture 112, as illustrated in FIG. 1B. For example, a remote control 114 may be removably attached to the radiographic source capsule 102 to control a position of the radiographic source capsule 102 (e.g., the stored position, the projection position). For example, the remote control 114 may physically engage the control cable 116 to advance or retract the control cable 116 relative to the remote control 114. By connecting the remote control 114 to the source capsule 102 via a control cable 116, the remote control 114 may be manipulated (e.g., cranked) to push or pull the radiographic source capsule 102 to a desired position within the housing 104.

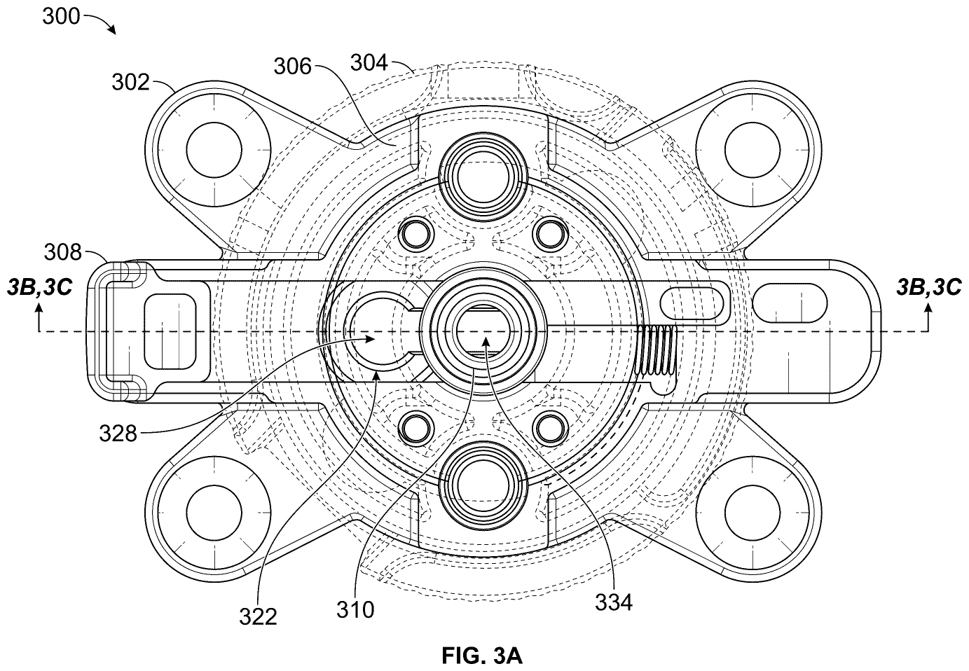

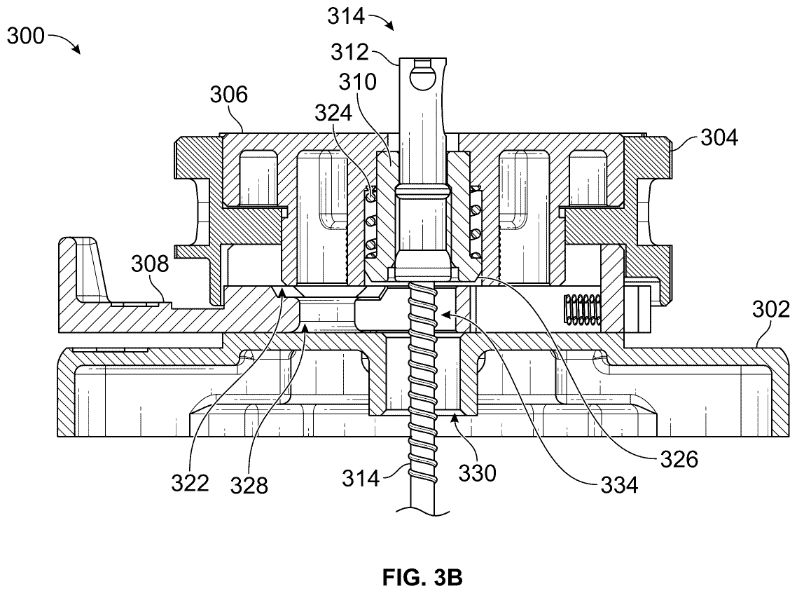

To control the position of the radiographic source capsule 102, the radiography source housing 104 enables connection of the control cable 116 to the radiographic source capsule 102 for exposure and retraction of the radiographic source capsule 102. The control cable 116 may be physically attached or connected to a drive cable 118 via a control connector 122. A distal end of the drive cable 118 is attached to the radiographic source capsule 102, and a proximal end of the drive cable 118 is attached to the control connector 122. The control connector 122 is removably connectable to the control cable 116 via a remote connector, as illustrated in FIG. 3B described below.

When engaged, the control cable 116 is controlled to extend into and through the radiographic source passage 106 to push the radiographic source capsule 102 to an exposed position adjacent the aperture 112. Conversely, the control cable 116 is retracted to pull the radiographic source capsule 102 from the exposed position back into the radiographic source passage 106 to the shielded position, at which time the control cable 116 may be detached from the radiographic source capsule 102. Additionally, the control cable 116 may be used to extend the radiographic source assembly 120 out of the shield 108 for service or replacement of the radiographic source capsule 102, such as when the radiographic source capsule 102 has decayed or depleted sufficiently to no longer be effective for radiography. The control cable 116 may similarly be used to retract a replacement radiographic source assembly 120 into the shield 108.

A connector lock assembly 124 holds the radiographic source assembly 120 in position within the shield 108 to allow compliance with governmental regulations for conveyance of the radiographic source projector 100. The remote connector is configured to allow for unlocking of the connector lock assembly 124 and exposure of the radiographic source capsule 102 when the control cable 116 is securely connected to allow for full retraction and locking of the radiographic source assembly 120.

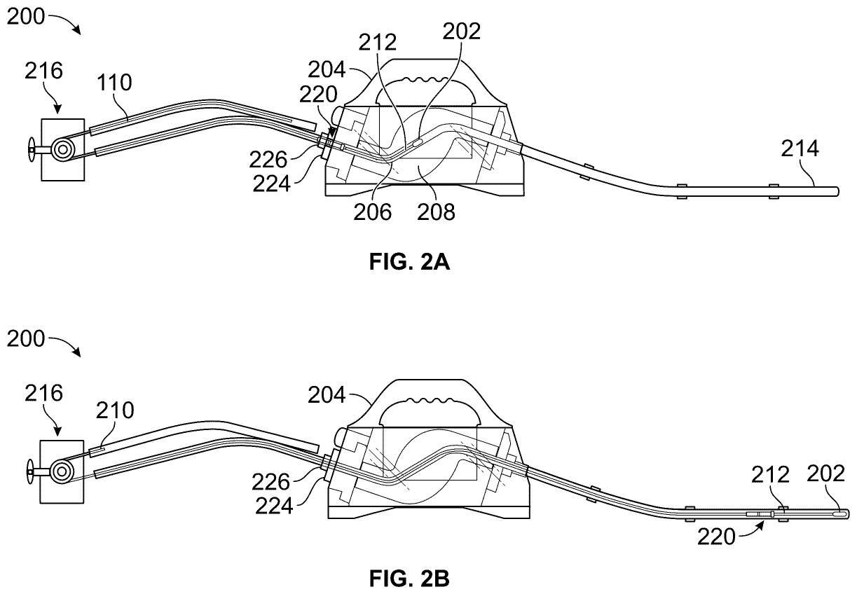

FIGS. 2A and 2B illustrate another example radiographic source projector 200 for providing radiation for radiography. The radiographic source projector 200 of FIG. 2 includes a radiographic source capsule 202 which is contained within a radiography source housing 204. the radiographic source capsule 202 may be similar or identical to the example radiographic source capsule 102 disclosed above, and emits radiation (e.g., X-rays, gamma rays) due to decay of the material. In contrast with the example projector of FIGS. 1A and 1B, the example radiographic source projector 200 of FIGS. 2A and 2B extend the source capsule 202 to a position external to the housing 204 for exposing the source capsule 202, which may require larger exclusion zones during radiography than the example radiographic source projector 100 of FIGS. 1A and 1B.

The radiography source housing 204 includes a radiographic source passage 206 (e.g., an S-shaped source tube) within a shield 208. The radiographic source passage 206 provides a pathway for the radiographic source capsule 202 to be exposed to an exterior of the shield 208, which in this example is constructed from depleted uranium, and retracted to a shielded position within the interior of the shield 208. FIG. 2A illustrates the radiographic source capsule 202 in the shielded position, and FIG. 2B illustrates the radiographic source capsule 202 in an exposed position.

The example radiographic source capsule 202 is part of a radiographic source assembly 220, which also includes a drive cable 212 and a control connector 222. The position of the radiographic source capsule 202 may be controlled via a control cable 210 and remote control 216 similar to the control cable 116 and the remote control 114 of FIGS. 1A and 1B. The control cable 210 is connected to the control connector 222 and to the radiographic source capsule 202.

The example radiographic source projector 200 further includes a connector lock assembly 224, which connects to a remote connector lock 226 of the remote control 216.

In the radiographic source projector 200 of FIGS. 2A and 2B, the exposed position of the radiographic source capsule 202 may be controlled by a guide tube 214, through which the radiographic source capsule 202 travels as the source capsule 202 is pushed by the control cable 210. The control cable 210 has sufficient column strength to push the radiographic source capsule 202 through the radiographic source passage 206 and through the guide tube 214.

Some operators may desire to replace the radiographic source capsule 102, 202 with a different type of radiographic source, such as a different isotope or an isotope of higher energy. However, such changes may not be satisfactory from a regulatory standpoint due to mismatches between shielding materials and the radiographic source capsule 102, 202. Alternatively, some operators may seek to replace the radiographic source capsule 102, 202 with the same type of source, but may not have the knowledge required to perform such a replacement correctly. Whether accidental or intentional, conventional radiographic systems do not prevent errors in radiographic source replacement.

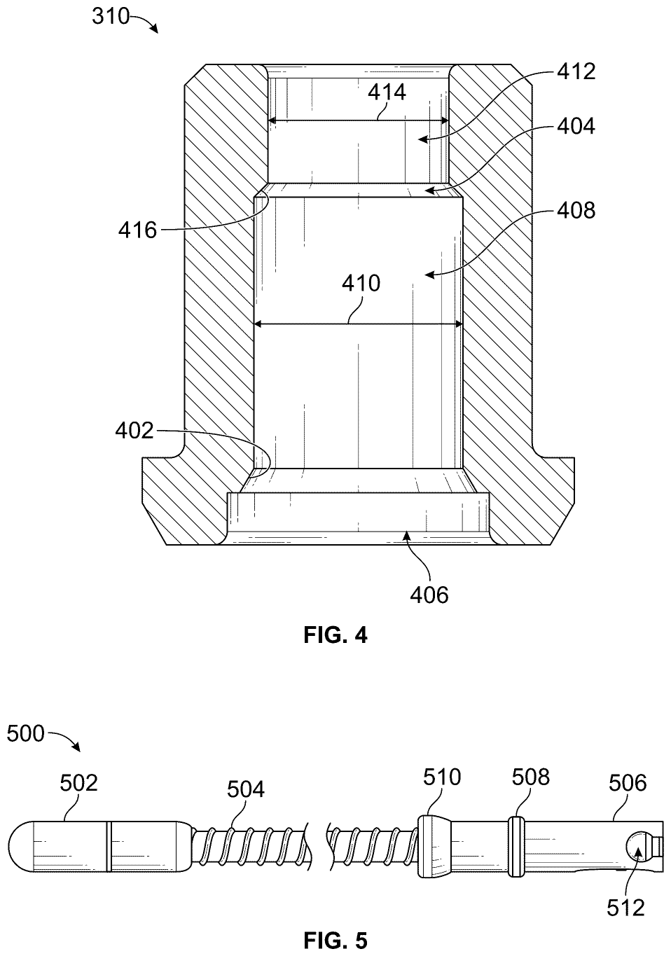

FIGS. 3A, 3B, and 3C illustrate an example connector lock assembly 300 that prevents installation of a radiographic source assembly that is not keyed for use with the connector lock assembly 300. Additionally, FIG. 5 illustrates an example radiographic source assembly 500 that is keyed for use with the example connector lock assembly 300 and prevents installation of the radiographic source assembly 500 into connector lock assemblies which are unkeyed or differently keyed.

FIG. 3A is a front view of the example FIG. 3B is a cross-sectional view of an example connector lock assembly 300 that may be used to implement the lock assemblies 124, 224 of FIGS. 1A-2B. The connector lock assembly 300 of FIG. 3A is shown in a locked position.

The example connector lock assembly 300 of FIG. 3A is attached to a face plate or other structure of the housing 204. The connector lock assembly 300 includes a selector body 302, a selector ring 304, a selector ring retainer 306, a locking slide 308, and a sleeve 310. An example implementation of aspects of the connector lock assembly 300 is described in U.S. Pat. No. 5,065,033 (Parsons), granted Nov. 12, 1991, entitled “Connector lock assembly.” The entirety of U.S. Pat. No. 5,065,033 is incorporated by reference herein.

In the illustrated example of FIG. 3B, a control connector 312 of a radiographic source assembly 314 is in a locked position within the sleeve 310. The sleeve 310 and the control connector 312 are held in the locked position by the locking slide 308, which is in the locked position in FIG. 3B. A drive cable 316 of the radiographic source assembly 314 extends through a narrow channel 318 in the locking slide 308.

The remote control 114, 216 of FIGS. 1A, 1B and/or 2A, 2B is connected to the control connector 312 to extend and retract the radiographic source assembly 314. FIG. 3C illustrates an example remote connector 320 connected to the control connector 312. In the example of FIG. 3C, the selector ring 304 is turned to an “operate” selection, and the locking slide 308 is slid into an unlocked position. As the locking slide 308 is pushed toward the unlocked position, a recess seat 322 of the locking slide 308 comes into alignment with the sleeve 310. A sleeve spring 324, pushes against a flange 326 of the sleeve 310 to push the flange 326 into the recess seat 322. The engagement of the sleeve 310 holds the locking slide 308 in a position so that a clearance hole 328 of the locking slide 308 is in alignment with the sleeve 310 and a radiographic source passage 330 of the selector body 302.

With the clearance hole 328 aligned with the sleeve 310, the control connector 312 of the radiographic source assembly 314 is freed for movement through clearance hole 328 towards an exposed position (e.g., through the housing 104, 204). The radiographic source assembly 314 is advanced by movement of the control cable 116, 210, which is attached to the source cable assembly via the control connector 312 and a remote connector 332. The control cable 116, 210 advances the radiographic source assembly 314 with the radiographic source capsule 102, 202 to a desired location for operation of the radiographic source capsule 102, 202. Upon completion of the function performed by the radiographic source capsule 102, 202, the control cable 116, 210 is rewound to retract the radiographic source capsule 102, 202 to a stored position within the shield 108, 208.

The control cable 116, 210 is rewound until the control connector 312 of the radiographic source assembly 314 enters the radiographic source passage 330 of the selector body 302, continues through clearance hole 328 of the locking slide 308, and into the sleeve 310. The locking slide 308 further include a narrow slot 334 that is aligned with the sleeve 310 when the locking slide 308 is in a locked position.

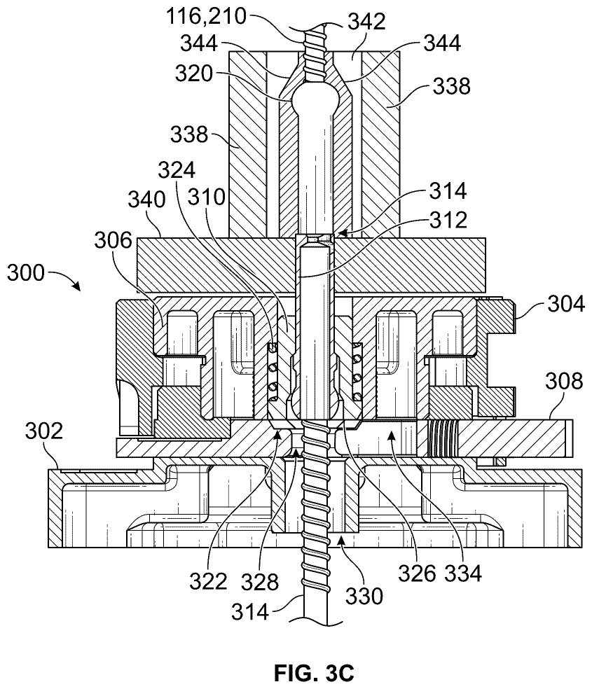

The example sleeve 310 includes a keying feature to prevent use of unkeyed or differently keyed control connectors from engaging the locking slide 308. FIG. 4 is a cross-sectional view of the example sleeve 310 of FIGS. 3B and 3C. The sleeve 310 includes a retention feature 402 and a keying feature 404 that allows the control connector 312, which has a matching keying feature, to disengage the sleeve 310 from the recess seat 322 of the locking slide 308. FIG. 5 is a side view of an example radiographic source assembly 500 that may be used to implement the radiographic source assemblies 120, 220, 314 of FIGS. 1A-3C. The example radiographic source assembly 500 includes a radiographic source capsule 502 (e.g., the radiographic source capsules 102, 202 of FIGS. 1A-2B), a drive cable 504, and a control connector 506.

The sleeve 310 defines an internal volume 406, such as a bore. A first portion 408 of the internal volume 406 has a first diameter 410, and a second portion 412 of the internal volume 406 has a second diameter 414. The first diameter 410 is larger than the second diameter 414. The control connector 506 includes a keying feature 508 which has a first diameter. The example keying feature 508 is a ring-shaped portion of the control connector 506, and may be integrally formed or permanently attached (e.g., welded) onto the control connector 506. In other examples, the keying feature 508 is a ball-shaped feature or has another shape, size, and/or position that matches and actuates the action surface 416. The keying feature 508 is dimensioned to pass through the first portion 408 of the sleeve 310 and to contact an action surface 416 at a proximal end of the first portion 408. The example action surface 416 may be tapered, stepped, and/or have any other shape, size, and/or position that matches a corresponding keying feature on the control connector 506. The example action surface is at least 12 millimeters from the distal end of the sleeve 310 toward the proximal end of the sleeve 310, to prevent actuation of the sleeve 310 by non-keyed or differently keyed radiographic source assemblies.

The retention feature 510 has a larger diameter than the keying feature 508, and is dimensioned to fit through the clearance hole 328 but not to fit through the narrow slot 334. When the locking slide 308 is in the locked position, the retention feature 510 retains the control connector 506 within the sleeve 310 via contact with the locking slide 308. The example retention feature 510 is a ball-shaped portion of the control connector 506, and may be integrally formed or permanently attached (e.g., welded) onto the control connector 506. In other examples, the retention feature 510 may be ring-shaped or have another shape, size, and/or position that does not pass through the slot 334 in the locking slide 308.

In some examples, the control connector 506 further includes visual cues indicating the type of radiographic source assembly and/or the type of radiographic projector having the matching keying features. Such examples may include coloring, identifiers of the isotope, identifiers of the radiographic source assembly and/or identifiers of the type of radiographic projector.

The sleeve 400 further includes a flange 418 to engage the recess seat 322 of the locking slide 308, as described above.

As the control connector 506 is pulled into the sleeve by the control cable 116, 210, the keying feature 508 makes contact with the action surface 416 defined by the keying feature 404 and actuates the sleeve 400 (e.g., to overcome the spring force by the sleeve spring 324) to unseat the sleeve 400 from the recess seat 322. With this force, the flange 418 of the sleeve 310 is pulled out of the recess seat 322 of the locking slide 308, which releases the locking slide 308. Once released, the locking slide 308 is urged toward a locked position a locking spring 336. With the motion toward the locked position, the narrow slot 334 of the locking slide 308 slides around the drive cable 504 and captures the retention feature 510 in the sleeve 310, thereby locking the radiographic source assembly 314 in the stored position.

With reference to FIG. 3C, the remote connector 320 may be connected to and disconnected from the control connector 312 when the control connector 312 is in the locked position. In some examples, the selector ring 304 is rotated to a designated position to allow for unlocking of the remote connector 320.

The remote connector 320 may include a ball or other protrusion which is inserted into and removed from a corresponding recess 512 of the control connector 312. After insertion of the protrusion into the control connector 312, jaws 338 are closed onto the control connector 312 and a connector collar 340 is positioned over the jaws 338 to secure the remote connector 320 to the control connector 312. In some examples, the connector collar 340 disengages a locking mechanism in the selector body 302 and/or the selector ring 304 to permit rotation of the selector ring 304 and unlocking of the locking slide 308. An example implementation of the remote connector 320, the jaws 338, and the connector collar 340 is described in U.S. Pat. No. 5,065,033.

A connector body 342 is coupled to the jaws 338, and provides a stop feature 344 that stops the remote connector 320 from retracting farther than the stop feature 344. The stop feature 344 and the jaws 338 may be dimensioned such that the remote connector 320 contacts the stop feature 344 at the time, or shortly after, the sleeve 310 is actuated to release from the recess seat 322 and the locking slide 308 moves to the locked position. As a result, the control connector 312 has a limited range of movement (e.g., no effective range of motion) in the locked position.

Due to the limited range of movement of the control connector 312 toward the proximal end, the example connector lock assembly 300 does not lock when a radiographic source assembly is inserted which does not include the keying feature 508 or includes a different keying feature. For example, a control connector that lacks the keying feature 508 (e.g., a control connector that includes only a ball as shown in U.S. Pat. No. 5,065,033) would not be able to actuate the sleeve 310, because the remote connector 320 would be stopped by the stop feature 344 of the connector body 342, thereby preventing the ball from actuating the sleeve 310. In some examples, the proximal end of the keying feature 508 is at least 12.5 millimeters (mm) closer than the distal end of the retention feature 510 to the proximal end of the control connector 506 to ensure that the retention feature 510 does not actuate the sleeve 310.

In the illustrated example, the keying feature 508 and the retention feature 510 are separated by a length 514 having a smaller diameter than either of the keying feature 508 and the retention feature 510. The smaller diameter of the length 514 may provide interoperation or backwards-compatibility with conventional source assembly transport packages and/or with conventional source loading devices. In other examples, the length 514 between the keying feature 508 and the retention feature 510 has a same diameter as the keying feature 508.

Furthermore, without locking the control connector 312, the connector collar 340 and the jaws 338 cannot be released due to the interlocking between the connector collar 340 and the selector ring 304, and the selector ring 304 cannot be rotated without the locking slide 308 being in the locked position. Accordingly, the keying feature 508 prevents use of a different radiographic source.

Furthermore, the keying feature on the control connector 312 prevents use in conventional connector lock assemblies having sleeves that do not have keying features, and/or use in connector lock assemblies that have different keying features. For example, if the example radiographic source assembly 500 is attempted to be inserted in a connector lock assembly such as that described in U.S. Pat. No. 5,065,033, or in a connector lock assembly in which the action surface 416 is closer than the distance between the keying feature 508 and the retention feature 510, the keying feature 508 would actuate the sleeve while the retention feature 510 is blocking movement of the locking slide 308. As a result, the locking slide 308 would not be able to move to the lock position, and the radiographic projector would not be approved for transport under governmental regulations due to the inability to lock the radiographic source capsule 102, 202 in the shielded position.

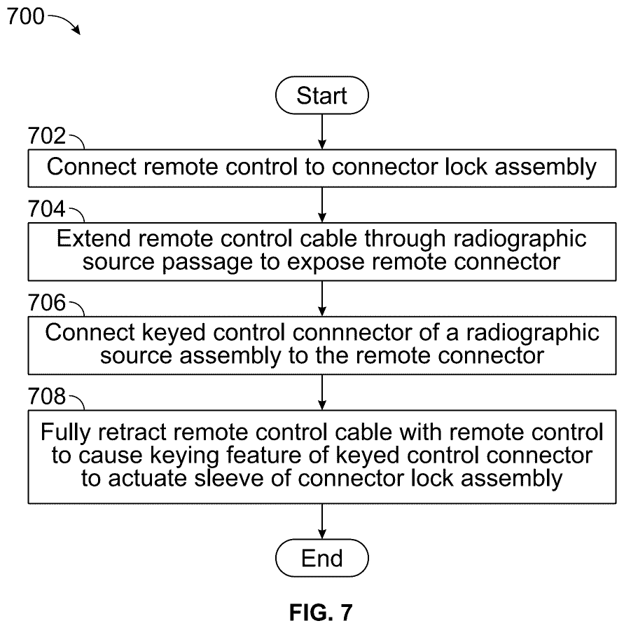

FIG. 7 is a flowchart representative of an example method 700 which may be performed to load a radiographic source assembly (e.g., the radiographic source assembly 500 of FIG. 5) including a keyed control connector 506 into a radiographic source projector (e.g., the radiographic source projector 100, 200 of FIGS. 1A-2B) having a keyed connector lock assembly. The example method 700 may be performed on initial installation of a radiographic source assembly and/or to replace a depleted radiographic source assembly.

At block 702, a remote control is connected to the connector lock assembly. For example, the remote connector 320, the jaws 338, and the connector collar 340 are connected to the connector lock assembly 300 of FIG. 3C. The connector lock assembly 300 may be further unlocked by operating the selector ring 304 and the locking slide 308.

At block 704, the remote control cable (e.g., the control cable 116, 210) is extended through the radiographic source passage (e.g., the radiographic source passage 106, 206, 330) to expose the remote connector 320. When an existing radiographic source assembly is already attached to the remote connector 320, the radiographic source assembly is also exposed.

At block 706, a keyed control connector 506 of a radiographic source assembly 500 is connected the remote connector 320. When an existing radiographic source assembly (e.g., a keyed radiographic source assembly) is already attached to the remote connector 320, the existing radiographic source assembly is removed prior to attaching the keyed control connector 506.

In some examples, a comparison may occur between the existing keyed control connector and the replacement keyed control connector 506 to verify that the control connectors have the same keying features. For example, the personnel performing the replacement may compare coloring or other markings on the control connectors to verify that the replacement keyed control connector 506 matches the control connector being replaced.

At block 708, the remote control cable 116, 210 is fully retracted with the remote control 114, 216 to cause the keying feature 508 of the keyed control connector 506 to actuate the sleeve 310 (e.g., by contacting the matching keying feature 404). The actuation of the sleeve 310 allows the locking slide 308 to lock the keyed control connector 506 and the radiographic source assembly 500 in the stored position. The remote connector 320 may then be removed. The example method 700 then ends.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made, and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A radiographic source assembly, comprising:
a radiographic source capsule comprising a sealed radiographic material;
a drive cable connected to the radiographic source capsule at a distal end of the drive cable; and
a control connector, a distal end of the remote control connector being connected to a proximal end of the drive cable and configured to receive a remote connector, the control connector comprising a lock retention feature and a keying feature positioned closer than the lock retention feature to the proximal end of the control connector.

2. The radiographic source assembly as defined in claim 1, wherein the lock retention feature comprises a ball-shaped portion or a ring-shaped portion of the remote control connector.

3. The radiographic source assembly as defined in claim 1, wherein the lock retention feature has a larger diameter than the keying feature.

4. The radiographic source assembly as defined in claim 1, wherein the keying feature comprises a ball-shaped portion or a ring-shaped portion of the remote control connector.

5. The radiographic source assembly as defined in claim 1, wherein at least one of the lock retention feature or the keying feature is integrally formed with the control connector.

6. The radiographic source assembly as defined in claim 1, wherein at least one of the lock retention feature or the keying feature is permanently attached to the control connector.

7. The radiographic source assembly as defined in claim 1, wherein a proximal end of the keying feature is at least 12.5 millimeters closer than a distal end of the control connector.

8. A radiographic source projector, comprising:
a radiographic source passage extending through the radiographic source projector from a control end to an exposure end; and
a connector lock assembly at the control end of the radiographic source passage, the connector lock comprising:
a sliding lock having a first aperture and a channel and configured to slide between a locked position and an unlocked position, the first aperture having a larger diameter than the channel;
a first biasing member configured to bias the sliding lock towards the locked position;
a sleeve configured to engage the sliding lock when the sliding lock is in the unlocked position; and
a second biasing member configured to bias the sleeve towards the sliding lock;
wherein the sleeve comprises a retention feature and a keying feature configured to allow a control connector of a radiographic source assembly having matching keying features to disengage the sleeve from the sliding lock.

9. The radiographic source projector as defined in claim 8, wherein the sleeve comprises an internal volume having a proximal end and a distal end, the distal end being closer to the sliding lock, wherein a first portion of the internal volume of the sleeve has a first diameter and a second portion of the internal volume has a second diameter, the first diameter being larger than the second diameter.

10. The radiographic source projector as defined in claim 9, wherein the sleeve comprises an action surface at a proximal end of the first portion.

11. The radiographic source projector as defined in claim 10, wherein the action surface is at least 12 millimeters from the distal end of the sleeve toward the proximal end of the sleeve.

12. The radiographic source projector as defined in claim 8, wherein the sleeve is configured to remain engaged with the sliding lock in the absence of the keying features.

13. The radiographic source projector, comprising:
a radiographic source passage extending through the radiographic source projector from a control end to an exposure end; and
a connector lock assembly at the control end of the radiographic source passage, the connector lock comprising:
a sliding lock having a first aperture and a channel and configured to slide between a locked position and an unlocked position, the first aperture having a larger diameter than the channel;
a first biasing member configured to bias the sliding lock towards the locked position;
a sleeve configured to engage the sliding lock when the sliding lock is in the unlocked position; and
a second biasing member configured to bias the sleeve towards the sliding lock;
wherein the sleeve comprises a retention feature and a first keying feature; and a radiographic source assembly, comprising:
a radiographic source capsule comprising a sealed radiographic material and configured to travel through the radiographic source passage;
a drive cable connected to the radiographic source capsule at a distal end of the drive cable; and
a control connector, a distal end of the control connector being connected to a proximal end of the drive cable and configured to receive a remote connector, the control connector comprising:
a lock retention feature configured to retain the control connector in a locked position within the sleeve when the sliding lock is in the locked position; and
a second keying feature positioned closer than the lock retention feature to the proximal end of the control connector and configured to engage the first keying feature to disengage the sleeve from the sliding lock as the control connector moves toward a proximal end of the sleeve.

14. The radiographic source projector as defined in claim 13, wherein the sleeve comprises an internal volume having a proximal end and a distal end, the distal end being closer to the sliding lock, wherein a first portion of the internal volume of the sleeve has a first diameter and a second portion of the internal volume has a second diameter, the first diameter being larger than the second diameter.

15. The radiographic source projector as defined in claim 14, wherein the second keying feature of the control connector has a diameter that is smaller than the first diameter and larger than the second diameter.

16. The radiographic source projector as defined in claim 14, wherein the first keying feature comprises an action surface at a proximal end of the first portion, and the second keying feature is configured to actuate the sleeve via the action surface.

17. The radiographic source projector as defined in claim 16, wherein the action surface is at least 12 millimeters from the distal end of the sleeve toward the proximal end of the sleeve.

18. The radiographic source projector as defined in claim 13, further comprising a remote control, comprising:
a remote connector configured to releasably connect to a proximal end of the control connector;
a control cable; and
an actuator configured to actuate the remote connector via the control cable by extending the remote connector and retracting the remote connector,
wherein the remote connector comprises a stop feature configured to limit retraction, such that a second control connector having the lock retention feature and lacking the second keying feature is stopped by the stop feature from retracting a sufficient distance for the lock retention feature to actuate the sleeve.
